(19) United States
(12) Patent Application Publication
(10) Pub. No.: US 2025/0374082 A1
(43) Pub. Date: Dec. 4, 2025

(54) COLLABORATIVE COMMUNICATION FOR RADIO ACCESS NETWORK

(71) Applicant: Continental Automotive Technologies GmbH, Hannover (DE)

(72) Inventors: Hojin Kim, Regensburg (DE); David Gonzalez Gonzalez, Egelsbach (DE); Andreas Andrae, Frankfurt am Main (DE); Rikin Shah, Langen (DE); Shravan Kumar Kalyankar, Singapore (SG); Reuben George Stephen, Singapore (SG); Osvaldo Gonsa, Frankfurt (DE)

(73) Assignee: Continental Automotive Technologies GmbH, Hannover (DE)

(21) Appl. No.: 18/860,705

(22) PCT Filed: Apr. 20, 2023
(86) PCT No.: PCT/EP2023/060370

§ 371 Date: Oct. 28, 2024

(30) Foreign Application Priority Data
Apr. 27, 2022 (DE) 10 2022 204 054.6

(51) Int. Cl. H04W 24/02; H04W 8/22

(52) U.S. Cl. CPC H04W 24/02; H04W 8/22

(57) ABSTRACT

For Artificial Intelligence/Machine Learning (AI/ML) model based operation in wireless radio access network, different combinations of Base Station-User Equipment (BS-UE) formations are used to manage signaling traffic overhead and device power consumption due to AI/ML use. Multi-communication modes are selectively activated based on parameter set generated as ML parameter profile and UE ML capability profile information. UE mobility and clustering are also used to determine the relevant communication mode as triggering method.

### CROSS-REFERENCE TO RELATED APPLICATIONS

The present application is a National Stage Application under 35 U.S.C. § 371 of International Patent Application No. PCT/EP2023/060370 filed on Apr. 20, 2023, and claims priority from German Patent Application No. 10 2022 204 054.6 filed on Apr. 27, 2022, in the German Patent and Trademark Office, the disclosures of which are herein incorporated by reference in their entireties.

### TECHNICAL FIELD

Various embodiments generally relate to the field of wireless communications.

### BACKGROUND

Artificial intelligence (AI) or machine learning (ML) is used for many different applications and areas as it shows much higher contribution to performance improvement over the existing technologies. In wireless or mobile communication network, AI/ML can be also used for better performance in various use cases or applications when two or more devices are communicated wirelessly. However, there are also challenges to apply AI/ML and some of them include high signaling traffic load and device power consumption increase due to AI/ML operation in wireless devices.

In radio access network (RAN) with wireless devices in connection, it is necessary to consider interworking between mobile devices (UE) and base station (BS) with other network devices such as mobile edge compute device (MEC) and non-terrestrial network device (NTN), etc. so that AI/ML operation in RAN can overcome the key challenges of high signaling traffic load and device power consumption increase.

### BRIEF DESCRIPTION OF THE DRAWINGS

FIG. 1 illustrates a block diagram of an example wireless communications network environment for network devices (e.g., a UE, AN, gNB or an eNB) according to various aspects or embodiments.

FIG. 2 is a diagram showing example AI/ML module usage in radio access network in accordance with one or more embodiments.

FIG. 3 is a diagram showing the federated learning operation using AI/ML modules in radio access network in accordance with one or more embodiments.

FIG. 4 shows upper and lower tables illustrating multi-communication modes in accordance with one or more embodiments.

FIG. 5 illustrates ML parameters for AI/ML operation in accordance with one or more embodiments.

FIG. 6 illustrates a UE ML capability profile in accordance with one or more embodiments.

FIGS. 7A, 7B, 7C and 7D are diagrams illustrating various multi-communication modes for AI/ML operation in accordance with one or more embodiments.

FIG. 8 is a flow diagram depicting a method of operating a communication mode with AI/ML operation in accordance with one or more embodiments.

FIG. 9 is a diagram illustrating signaling flow of AI/ML operation with communication modes in accordance with one or more embodiments.

FIG. 10 is a flow diagram illustrating a method for a CRU in accordance with one or more embodiments.

FIG. 11 is a flow diagram illustrating a method for a CRU in accordance with one or more embodiments.

FIG. 12 is a diagram illustrating signaling flow for a mode with UE clustering communication in accordance with one or more embodiments.

FIG. 13 is a graph depicting a set of Gaussian distributions in accordance with one or more embodiments.

FIG. 14 is a diagram depicting single parameter UE clustering based AI/ML operation in accordance with one or more embodiments.

FIG. 15 is a diagram depicting multiple parameter UE clustering based AI/ML operation in accordance with one or more embodiments.

FIG. 16 is a diagram depicting operation of a BS and UEs with clustering with a codebook scheme in accordance with one or more embodiments.

FIG. 17 is a flow diagram depicting a method of selecting CRU for each cluster in accordance with one or more embodiments.

FIG. 18 is a diagram depicting UE mobility using BS-BS combined training in accordance with one or more embodiments.

FIG. 19 is a diagram depicting UE mobility using BS-BS split training in accordance with one or more embodiments.

FIG. 20 is a flow diagram illustrating a method using BS-BS combined training and/or BS-BS split training in accordance with one or more embodiments.

FIG. 21 is a flow diagram illustrating a method for UE mobility based triggering in accordance with one or more embodiments.

FIG. 22 is a diagram illustrating global model sharing in accordance with one or more embodiments.

FIG. 23 is a diagram illustrating global model sharing in accordance with one or more embodiments.

### DETAILED DESCRIPTION

The present disclosure will now be described with reference to the attached drawing figures, wherein like reference numerals are used to refer to like elements throughout, and wherein the illustrated structures and devices are not necessarily drawn to scale. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. Embodiments herein may be related to RAN1, RAN2, 5G and the like.

As utilized herein, terms “component,” “system,” “interface,” and the like are intended to refer to a computer-related entity, hardware, software (e.g., in execution), and/or firmware. For example, a component can be a processor, a process running on a processor, a controller, an object, an executable, a program, a storage device, and/or a computer with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising”.

Mobile communication has evolved from early voice systems to highly sophisticated integrated communication systems or platforms. Next generation wireless/mobile communication systems, such as 5G and new radio (NR) are expected to be a unified network/system that targets to meet different and even conflicting performance dimensions and services. Such diverse multi-dimensional requirements are driven by different services and applications. Generally, NR will evolve based on 3GPP LTE-Advanced with additional potential new radio access. Further, NR is expected to evolve with additional potential new radio access technologies (RATs) to enrich mobile communication with improved, simple and seamless wireless connectivity solutions. NR can enable mobile communication that provides fast and rich contents and services.

Artificial intelligence/machine learning (AI/ML) based techniques can be used with 3GPP. AI/ML can be used for 5G evolution and 6G phases.

AI/ML can be used for RAN applications, such as PHY, MAC, etc. by considering BS-UE/UE-UE collaboration scenarios to support AI/ML operations. AI/ML can facilitate interworking and data information flow in collaboration level for AI/ML support communication modes for AI/ML support.

One or more embodiments are disclosed that facilitate RAN applications by using AI/ML operations for collaboration scenarios and/or communications modes.

The one or more embodiments include, but are not limited to:

A Machine learning (ML) parameter profile consisting of multiple domains to configure each parameter set for multi-communication modes in ML operation.

A UE ML capability profile consisting of multiple domains to provide reference information about UE capability to perform ML operation.

A configuration of multi-communication modes and the associated operation flows.

A UE clustering mapping method for single parameter based selective codebook prioritization.

A UE clustering mapping method for multiple parameters based combined weighted prioritization.

Functionalities of a cluster reference UE (CRU) and CRU selection process.

A communication mode triggering method using UE clustering.

A Gaussian mixture model (GMM) based quantization method for codebook mapping process.

A UE mobility based BS-BS collaboration method for combined training and split training.

A UE mobility based triggering method for ML operation of model training.

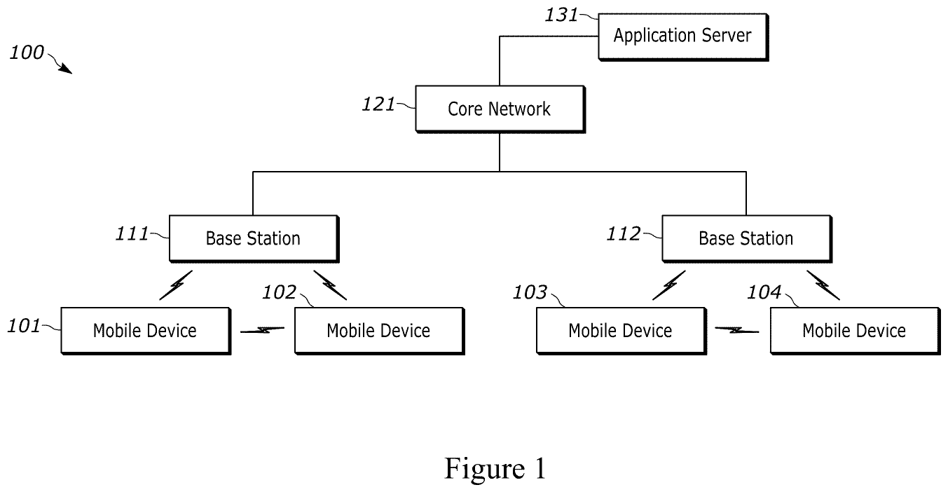

FIG. 1 illustrates an architecture of a system 100 of a network in accordance with some embodiments. The system 100 is shown to include a user equipment (UE) 101, 102, 103, and 104. The UEs 101˜104 are illustrated as smartphones (e.g., handheld touchscreen mobile computing devices connectable to one or more cellular networks), but can also comprise any mobile or non-mobile computing device, such as Personal Data Assistants (PDAs), pagers, laptop computers, desktop computers, wireless handsets, automotive devices (e.g., vehicles) or any computing device including a wireless communications interface.

In some embodiments, any of the UEs 101˜104 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data can be a machine-initiated exchange of data. An IoT network describes interconnecting IoT UEs, which can include uniquely identifiable embedded computing devices (within the Internet infrastructure), with short-lived connections. The IoT UEs can execute background applications (e.g., keep-alive messages, status updates, etc.) to facilitate the connections of the IoT network.

The UEs 101˜104 can be configured to connect, e.g., communicatively couple, with a radio access network (RAN) 111 and 112—the RAN 111 and 112 can be, for example, an Evolved Universal Mobile Telecommunications System (UMTS) Terrestrial Radio Access Network (E-UTRAN), a NextGen RAN (NG RAN), or some other type of RAN. The UEs 101˜104 connect to BSs wirelessly and the air interface technologies can be based on cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 101˜104 can further directly exchange communication data via sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). A network device as referred to herein can include any one of these APs, ANs, UEs or any other network component.

In this embodiment, the CN 121 provides the functions that communicate with the UE, store its subscription and credentials, allow access to external networks & services, provide security and manage the network access and mobility.

The ANs can include circuitry (e.g., baseband circuitry), a memory, a network interface (e.g., RF interface), one or more processors and the like.

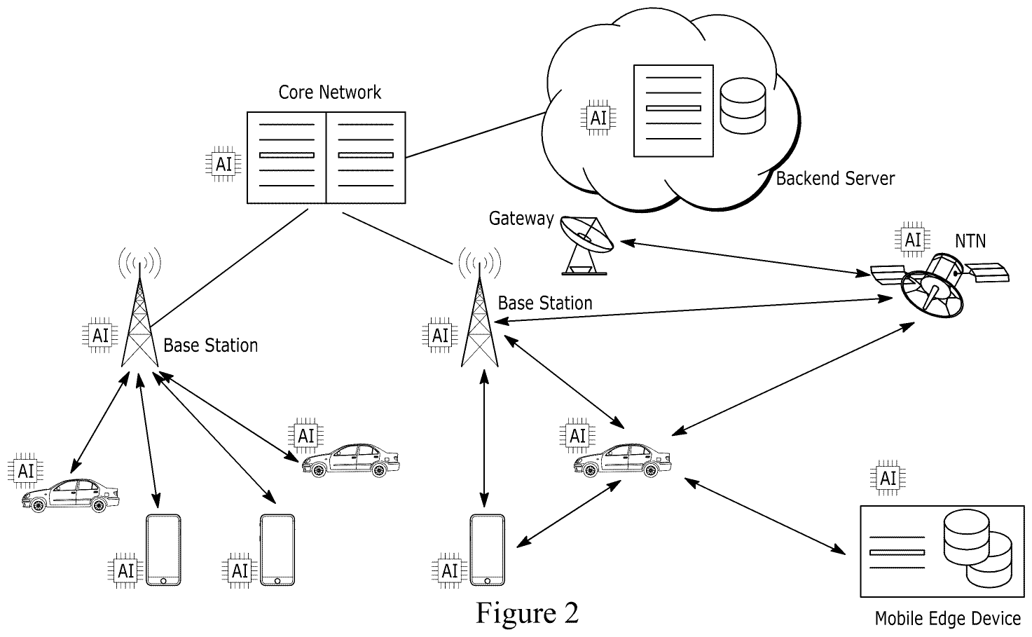

FIG. 2 is a diagram showing example AI/ML module usage in radio access network in accordance with one or more embodiments.

It is appreciated that BS-UE/UE-UE/BS-BS collaboration supports AI/ML operation in RAN.

In typical prior BS-UE/UE-UE/BS-BS communication behavior, there is no consideration of supporting AI/ML operation support.

Depending on different AI/ML training/models, BS-UE/UE-UE/BS-BS communication modes need to be specified for support.

Different configurations of BS-UE/UE-UE/BS-BS communication modes can enhance AI/ML operation performance. Examples of communications modes that can enhance this performance include network access mode, sidelink mode, broadcast/multicast mode and the like.

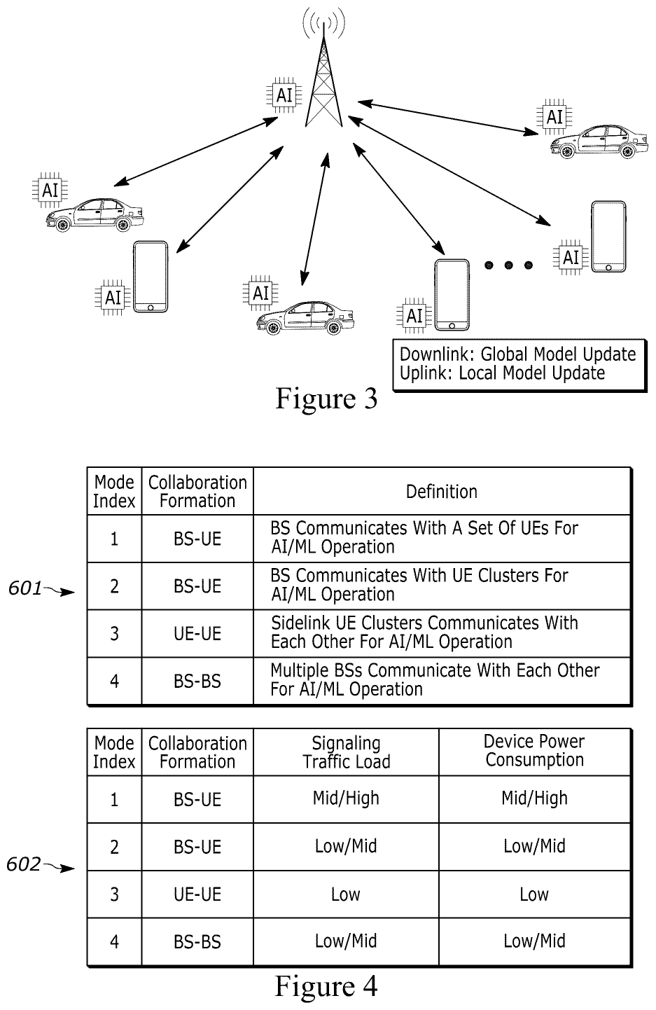

FIG. 3 is a diagram showing the federated learning operation using AI/ML modules in radio access network in accordance with one or more embodiments.

A global model in BS is distributed to each UEs by collecting local model update feedback from them.

In this kind of scenarios, the AI/ML training operation between BS and multiple UEs have the potential challenges such as heavy signaling traffic and increase of device power consumption.

Multiple communication modes for AI/ML operation include a UE clustering scenario and a non-UE clustering scenario.

The UE clustering is based on AI/ML operation under the UE clustering scenario.

The UE mobility is based on AI/ML operation under both UE clustering and non-UE clustering scenarios.

FIG. 4 shows upper and lower tables illustrating multi-communication modes in accordance with one or more embodiments.

The upper table 601 includes a mode index and associated collaboration formation types of BS/UE are defined causing AI/ML operation to be executed differently based on the mode index.

To determine communication mode(s) for AI/ML operation, a pre-defined ML parameter profile index configuration is used for mode selection. Additional details of the ML parameter profile are described infra.

The lower table 602 is about characteristics of the modes that indicate different combinations regarding signaling traffic load and device power consumption.

An improvement for signaling traffic load can be achieved for AI/ML operation based on mode selection.

The levels or amount of improvements are based on domains such as communication domain, device domain, training domain, task domain, application domain and the like.

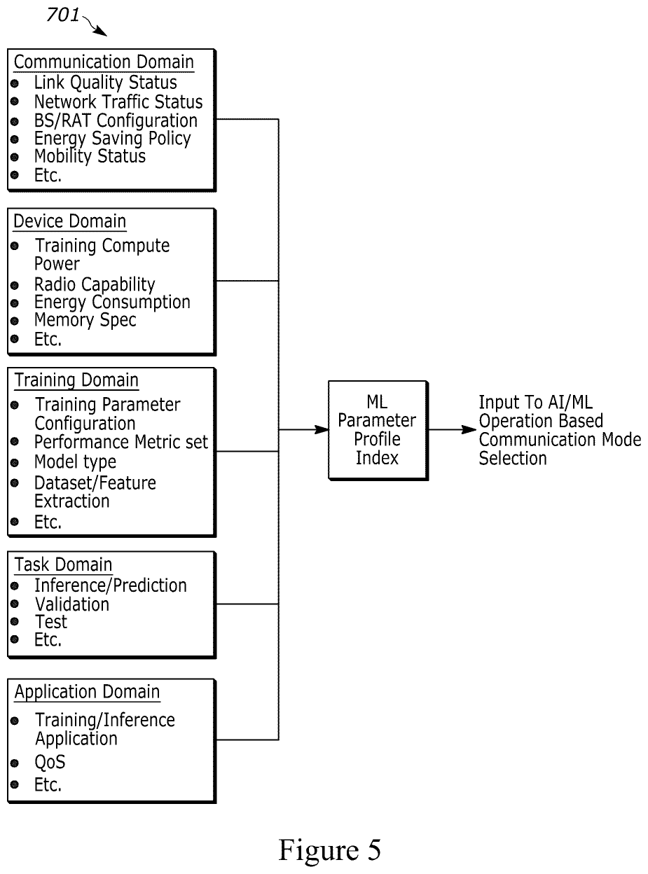

FIG. 5 illustrates ML parameters for AI/ML operation in accordance with one or more embodiments.

The ML parameter profile is generated to provide multi-domain parameter set so that a suitable communication mode selection is made for AI/ML operation in RAN.

A parameter profile index configuration includes the following: a communication domain, a device domain, a training domain, a task domain and an application domain.

The information listed in each domain of ML parameter profile can be obtained from different sources located in application server, core network, radio access network, UE devices, edge computing services and the like.

Multiple threshold values can also be pre-defined for parameters that work for communication mode switching.

701 shows an example of generating a ML parameter profile index for communication mode selection.

A UE ML capability profile can be generated to provide reference information about a UE's capability to perform AI/ML operation(s). The profile can also be used for UE clustering formation and cluster reference assignment criteria for multi-communication mode selection.

The UE ML capability profile is provided to a node (BS, MEC, etc.) through UE capability information message when RRC is set up.

A UE measurement report message can also be sent to the BS to provide communication domain information of UE ML capability profile.

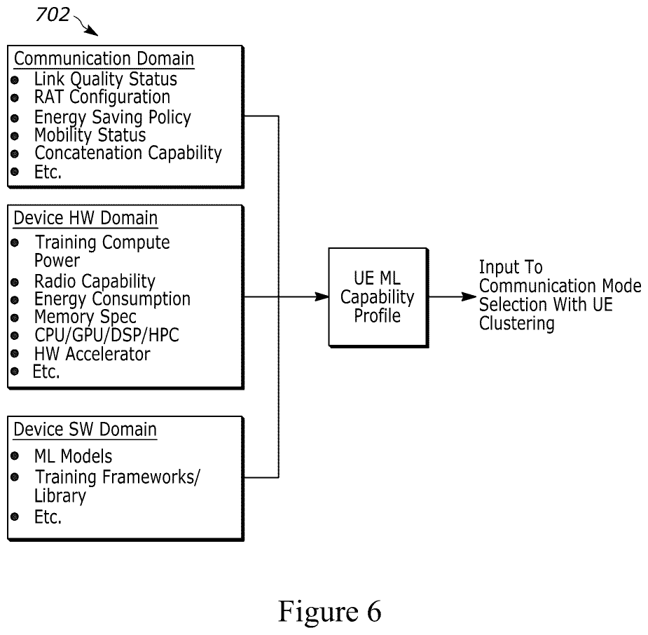

FIG. 6 illustrates a UE ML capability profile in accordance with one or more embodiments.

702 shows an example of generating UE ML capability profile(s).

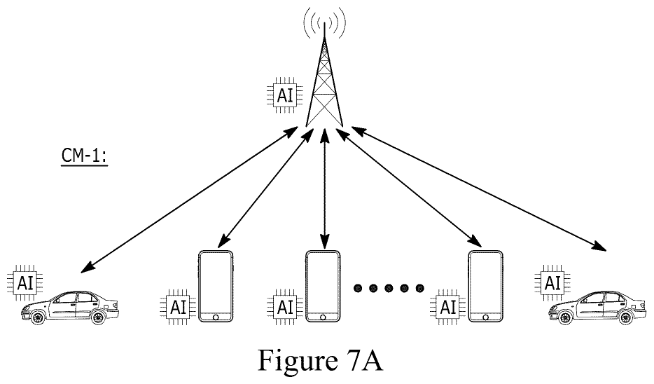

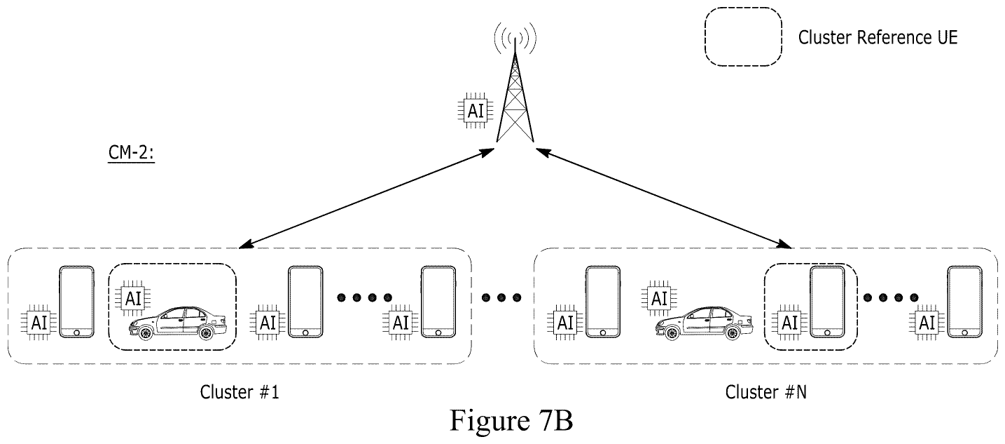

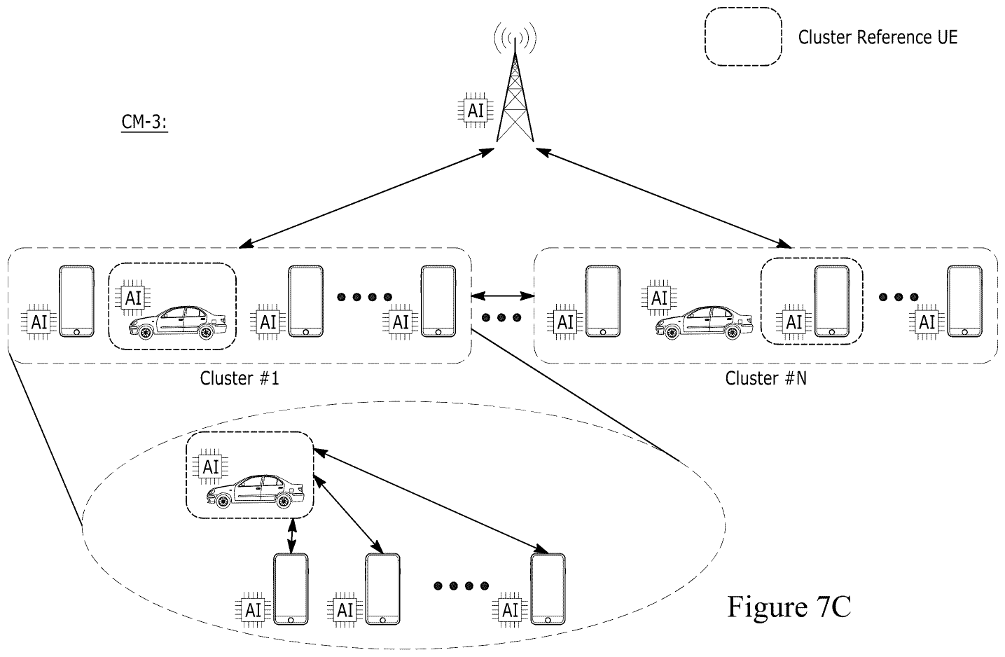

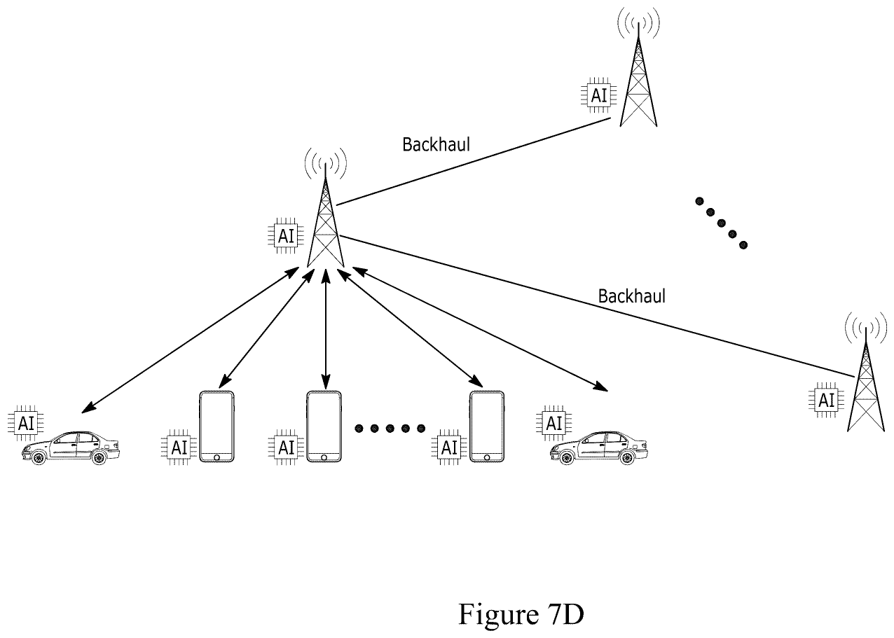

FIGS. 7A, 7B, 7C and 7D are diagrams illustrating various multi-communication modes for AI/ML operation in accordance with one or more embodiments.

FIG. 7A shows CM-1.

FIG. 7B shows CM-2.

FIG. 7C shows CM-3.

FIG. 7D shows CM-4.

In the CM-1 mode, a BS communicates with a set of UEs for AI/ML operation.

The location of AI/ML global model for training depends on implementation-specific. For example, it can be in BS, CN, MEC, or cloud server, or UE, etc.

In this assumption, the AI/ML global model can be located in BS. However, it can be also located elsewhere, such as in edge computing network or upper network or central server or any dedicated UE(s).

Each UE is capable of performing AI/ML local model training.

For AI/ML global model training, UE subset is selected among candidate UEs linked to BS for the pre-configured training round(s) based on the ML parameter profile index as selection criteria.

The AI/ML global model is trained based on the collection of AI/ML local model training update feedback from UEs.

In CM-2, a BS communicates with UE clusters for AI/ML operation.

The location of AI/ML global model for training depends on implementation-specific.

In this assumption, AI/ML global model can be located in BS. However, it can be also located in edge computing network or upper network or central server.

Each UE is capable of performing AI/ML local model training.

UE cluster(s) is/are formed for communication with BS and each cluster assigns a cluster reference UE (CRU) that represents the concatenated uplink transmission of AI/ML local model update by collecting AI/ML local model update from the clustered UE members.

AI/ML global model is trained based on the collection of AI/ML local model training update feedback from UE clusters.

From the available UE clusters, they can be also selectively chosen for AI/ML model training rounds based on AI/ML global model convergence performance or UE cluster status information as well as ML parameter profile updates. In other words, not all UE clusters need to be involved for AI/ML model training rounds

Selection criteria of CRU is separately specified.

In CM-3, sidelink communication is available between UE clusters for AI/ML operation.

The exact location of AI/ML global model for training depends on implementation-specific.

In this assumption, AI/ML global model can be located in BS. However, it can be also located in edge computing network or upper network or central server.

Each UE is capable of performing AI/ML local model training.

AI/ML cluster model can be also optionally used as alternative to global model if necessary.

Each cluster has its own cluster model for AI/ML training led by cluster ref UE (CRU) and optionally the cluster model update or the collected local model update is shared with BS and/or neighbor clusters.

AI/ML global model is trained based on the collection of AI/ML local model training update feedback from UE clusters.

Cluster-level AI/ML model training can be also optionally updated each other if necessary.

CRU of each cluster share the following information with other clusters:

Concatenated local model update information generated in each cluster and/or

Forwarded global model update from BS to any cluster(s) that fail the reception of it for their local model training update.

In CM-4, multiple BSs communicate with each other for AI/ML operation.

The exact location of AI/ML global model for training depends on implementation-specific.

In this assumption, AI/ML global model can be located in BS. However, it can be also located in edge computing network or upper network or central server.

Each UE is capable of performing AI/ML local model training.

UE clustering can be also combined into this communication mode.

AI/ML cluster model can be also optionally used as alternative to global model if necessary.

BSs are connected to each other with neighbor BSs through backhaul link and AI/ML model information is exchanged to support BS-BS combining based AI/ML model training.

AI/ML model training performed in each BS can be shared with each other.

The trained AI/ML model in each BS can be also used for transfer learning if necessary.

A lead BS can optionally take inclusion of other BS's UE local training model update from neighbor BSs when neighbor BSs cannot perform global model training (due to resource, energy, traffic load or lack of trainable UEs).

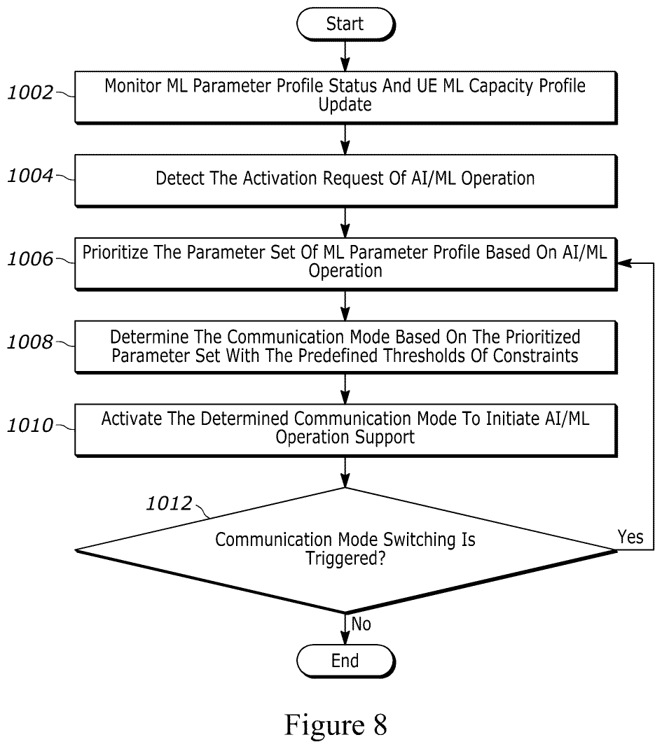

FIG. 8 is a flow diagram depicting a method of operating a communication mode with AI/ML operation in accordance with one or more embodiments.

A ML parameter profile status and UE ML capability profile update are monitored at 1002.

An activation request of AI/ML operation is detected at 1004.

A parameter set of a ML parameter profile is prioritized based on the AI/ML operation 1006.

A communication mode is determined based on the prioritized parameter set the pre-defined thresholds of constraints at 1008.

The determined communication mode is activated at 1010 to initiate AI/ML operation support.

A check for communication mode switching is performed at 1012. If yes, the method turns to 1006.

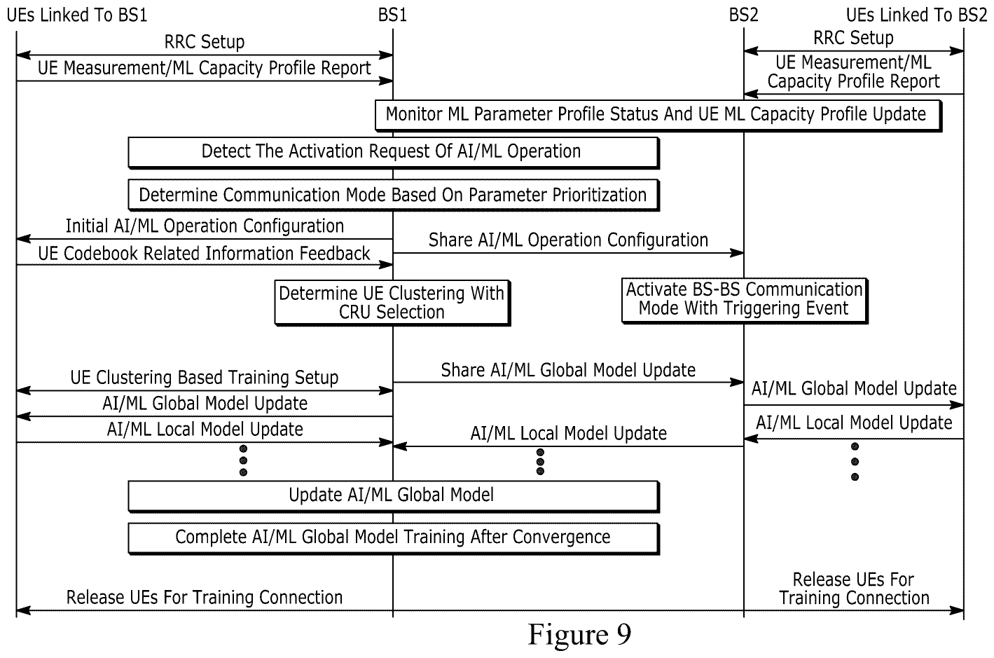

FIG. 9 is a diagram illustrating signaling flow of AI/ML operation with communication modes in accordance with one or more embodiments. The operation is provided for illustrative purposes and it is appreciated that suitable variations are contemplated.

The diagram includes a plurality of UEs linked to BS1, BS1, BS2, and a second plurality of UEs linked to BS2.

The first UEs and the BS1 perform an RRC setup. Additionally, the UEs provide UE measurement/ML capability profile report(s) to the BS1.

Similarly, the second UEs and the BS2 perform an RRC setup. Additionally, the second UEs provide UE measurement/ML capability profile report(s) to the BS2.

The BS1 and BS2 monitor ML parameter profile status and UE ML capability profile update.

The BS1 detects the activation request of AI/ML operation. Then, the BS1 determines a communication mode (CM-1, CM-2, CM-3 or CM-4) based on parameter prioritization.

The BS1 generates and provides an initial AI/ML operation configuration to the first BS1. Then, the first UEs provide UE codebook related information as feedback.

Additionally, the BS1 shares the AI/ML operation configuration with the BS2.

The BS1 determines UE clustering with CRU selection and the BS2 activates BS-BS communication mode with a triggering event.

The BS1 and the first UEs develop UE clustering based training setup. The BS1 shares an AI/ML global model update with the BS2.

The BS1 provides the AI/ML global model update to the first UEs. The first UEs provide an AI/ML local model update in response.

The BS2 shares the AI/ML global model update with the second UEs.

The second UEs provide an AI/ML local model update to the BS2 in response.

The BS2 provides the AI/ML local model update from the second UEs to the BS1.

The BS1 updates the AI/ML global model.

The BS1 completes AI/ML global model training after convergence.

The first UEs and the second UEs are released for training connection.

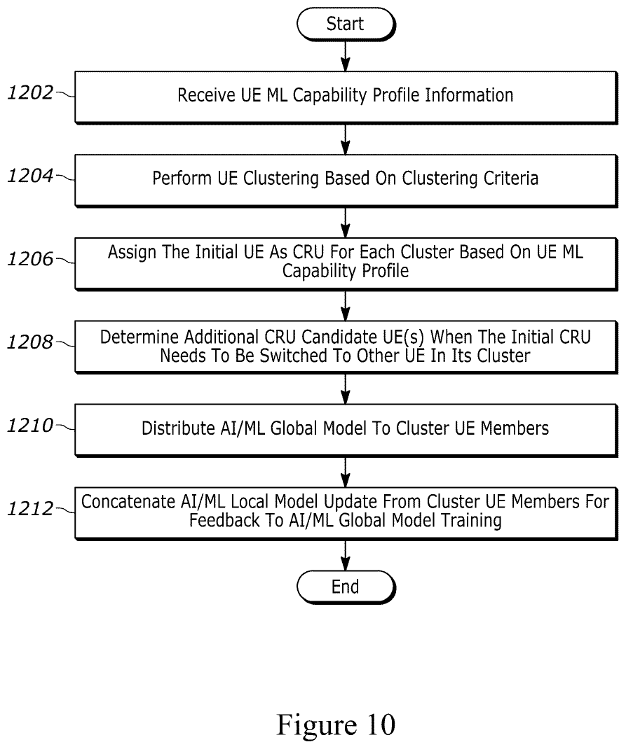

FIG. 10 is a flow diagram illustrating a method for a CRU in accordance with one or more embodiments. The operation is provided for illustrative purposes and it is appreciated that suitable variations are contemplated.

The method includes functionality of a cluster reference UE (CRU). The CRU represents the clustered UE members. The CRU concatenates the AI/ML local model update to feedback to BS or other clusters. The device type can vary such as mobile electronics, vehicular, mobile edge computing, etc.

The CRU performs the AI/ML cluster model (optionally).

The AI/ML cluster model is trained based on the aggregation of AI/ML local model update generated by the clustered UE members.

CRU selection is based on CRU device capability and the CRU capability criteria is implementation-specific based on UE ML capability profile.

Also priority of UE and service priority within a UE as part of CRU selection criteria.

UE ML capability profile information is received at 1202.

UE clustering is performed at 1204 based on clustering criteria.

The initial UE is assigned as CRU at 1206 for each cluster based on UE ML capability profile.

Additional CRU candidate UE(s) are determined at 1208 when the initial CRU is to be switched to an other UE in its cluster.

An AI/ML global model to cluster UE members is distributed at 1210.

An AI/ML local model is updated from cluster UE members at 1212 for feedback to AI/ML global model training.

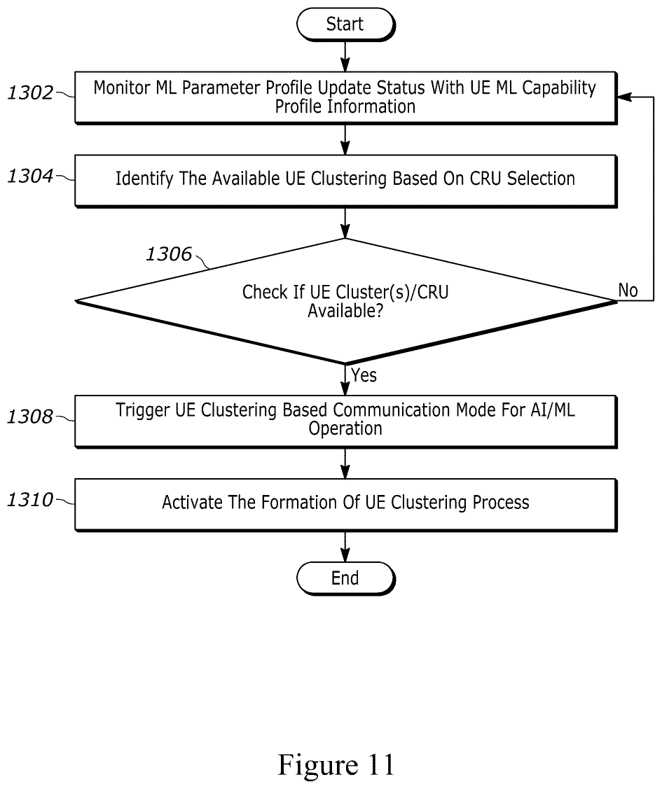

FIG. 11 is a flow diagram illustrating a method for a CRU in accordance with one or more embodiments. The operation is provided for illustrative purposes and it is appreciated that suitable variations are contemplated.

The method describes setting a communication mode triggering with UE clustering. The UE clustering is used to trigger communication mode(s) that enables UE cluster(s) for AI/ML operation.

The determination of communication mode to be used for AI/ML operation is based on ML parameter profile update and UE ML capability profile information.

At the same time, the UE cluster based communication mode can then be activated when CRU selection with UE clustering is available.

In this scenario, UE clustering works as triggering functionality to activate the associated communication mode.

A ML parameter profile update status with UE ML capability profile information is monitored at 1302.

An available UE cluster is identified at 1304 based on the CRU selection.

A check is performed at 1306 on if UE cluster(s)/CRU is/are available.

If yes at 1306, UE clustering based communication mode for AI/ML operation is triggered at 1308.

The formation of a the UE clustering is activated at 1310.

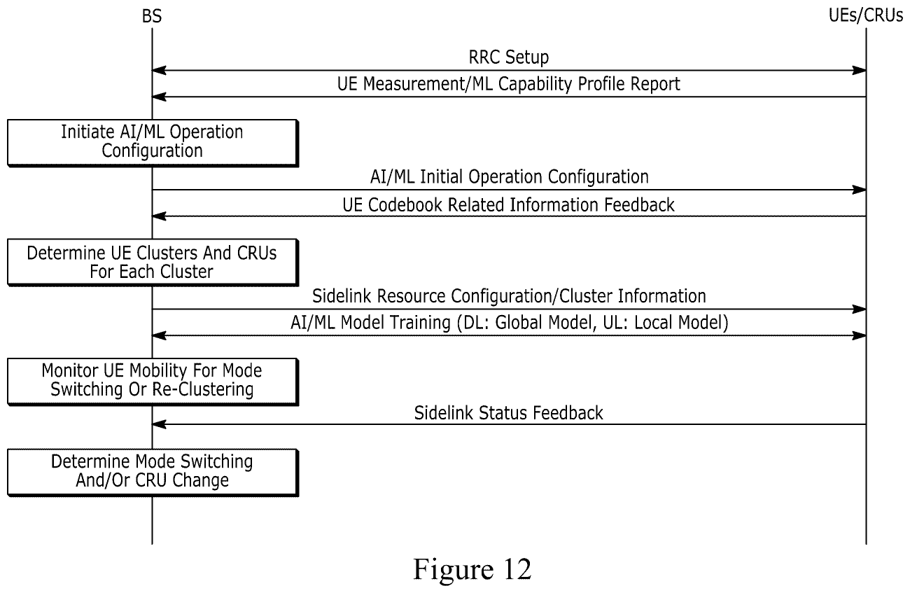

FIG. 12 is a diagram illustrating signaling flow for a mode with UE clustering communication in accordance with one or more embodiments. The operation is provided for illustrative purposes and it is appreciated that suitable variations are contemplated.

The diagram is described with regard to a base station (BS) and one or more UEs/CRUs. The flow can be performed in order from top to bottom as shown, however it is appreciated that suitable variations in order performed are contemplated.

An RRC setup is performed and signaled.

A UE measurement/ML capability profile report is provided by the UEs/CRUs.

The BS initiates AI/ML operation configuration.

The BS provides the AI/ML initial operation configuration to the UEs/CRUs.

The UEs/CRUs provide codebook related information feedback to the BS.

The BS determines UE clusters and CRUs for each cluster.

Sidelink resource configuration/cluster information is provided by the BS to the UEs/CRUs.

AI/ML model training is performed (downlink (DL): global model, uplink (UL): local model).

The BS monitors UE mobility for mode switching and/or re-clustering.

The UEs/CRUs provide sidelink feedback to the BS.

The BS determines mode switching and/or CRU change.

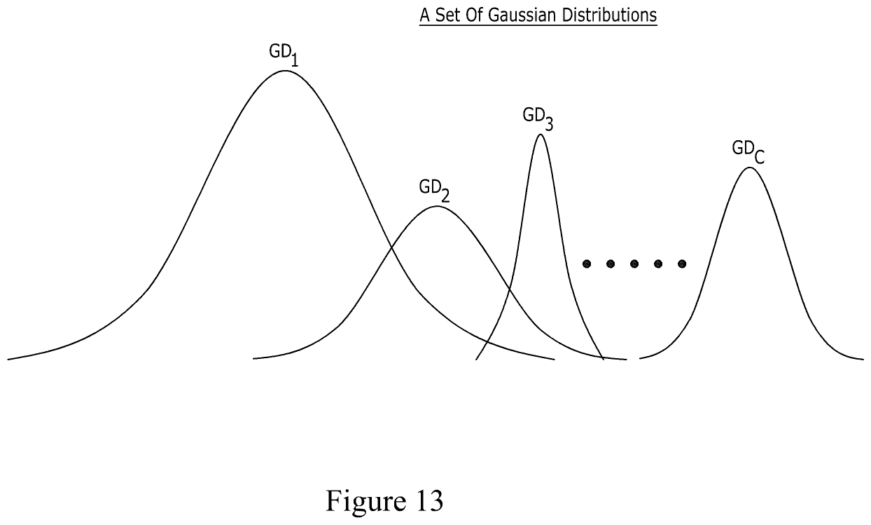

FIG. 13 is a graph depicting a set of Gaussian distributions in accordance with one or more embodiments. The graph is provided for illustrative purposes and it is appreciated that suitable variations are contemplated.

It is appreciated that UE clustering is substantially based on a ML parameter profile index and a UE ML capability profile information.

For efficient AI/ML global model training operation, each UE cluster can have a reduced or minimization of imbalanced data distributions of local datasets of cluster UE members.

For this purpose, a Gaussian Mixture Model (GMM) is utilized to compensate for the imbalanced data distributions of local datasets of cluster UE members.

Based on local data distribution information from each UEs, an initial number of clusters is set and each UEs are then assigned to the cluster index where UEs have the same cluster index chosen.

At the same time, two or more parameters can be used for UE clustering as decision criteria by generating multi-codebook based quantization. In this case, UE local data distribution can be one of parameters and more parameters can be considered to be used together before assigning UEs to any cluster index.

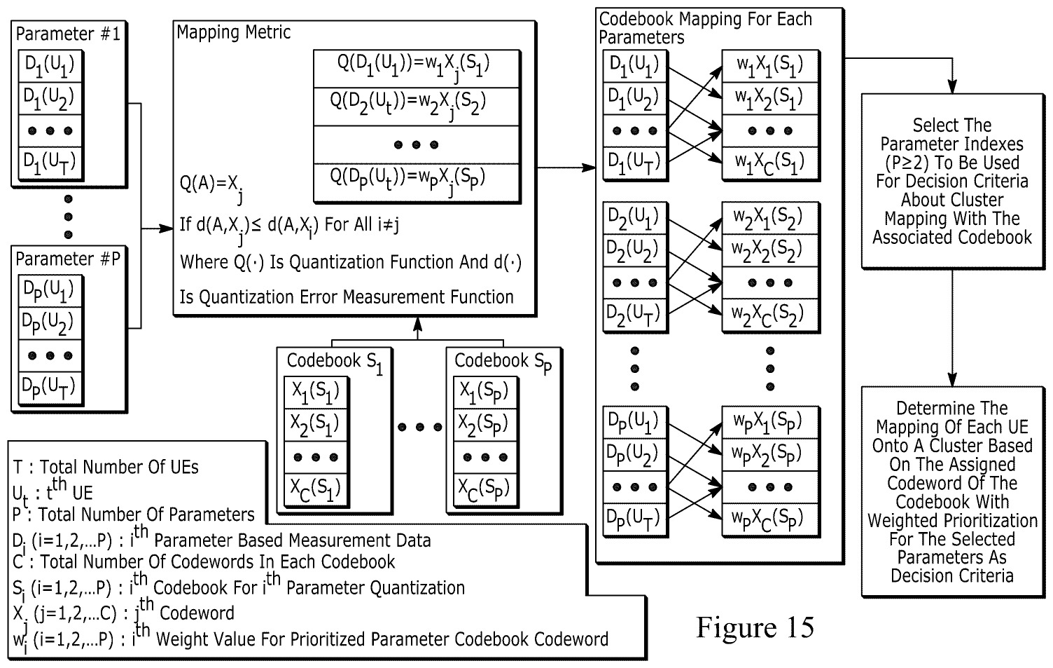

The Gaussian distributions shown in FIG. 15 depict data distributions of local datasets of cluster UE members. for this example:

Using GMM, a certain number of Gaussian distributions (GDᵢ where i=1, . . . , C) are defined and each of these distributions represent a cluster where the clustered UE members have similar local data distribution based on quantization method.

A set of Gaussian distributions for quantization is expressed as GDᵢ: {μᵢ, σᵢ} as i^{th} set of {mean, variance}

Firstly, “codeword” is defined to represent the quantized value of data distribution as Xᵢ (i^{th} codeword).

The set of all codewords is then defined to be “codebook”.

A quantization technique of forming clusters is also described. For this technique, when clustering UEs with similarity of parameter(s), the number of UE clusters need to be limited as configurable. The limited number of parameter data are determined to represent all available data distributions of candidate cluster UE members for mapping. By adopting any single parameter for quantization codebook or multiple parameters for multi-codebook, the decision criteria of UE clustering can be made. Mapping criteria can be based on the quantization error measurement. In this way, signaling traffic overhead in UE cluster based AI/ML operation such as federated learning can be reduced.

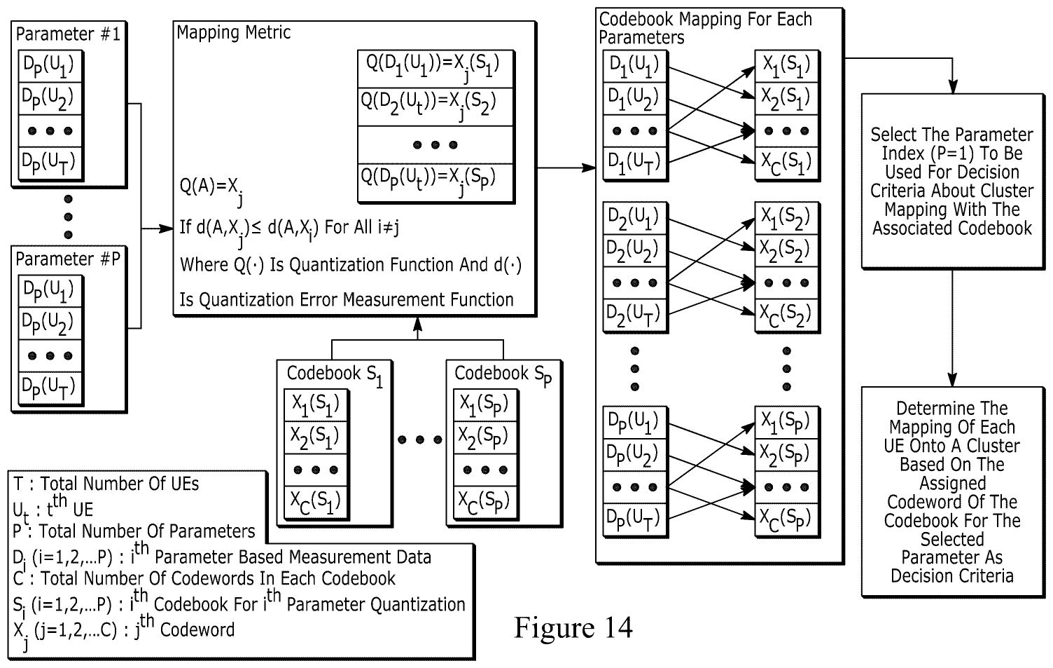

FIG. 14 is a diagram depicting single parameter UE clustering based AI/ML operation in accordance with one or more embodiments. The diagram is provided for illustrative purposes and it is appreciated that suitable variations are contemplated.

The diagram shows single parameter based selective codebook prioritization for UE cluster mapping.

FIG. 15 is a diagram depicting multiple parameter UE clustering based AI/ML operation in accordance with one or more embodiments. The diagram is provided for illustrative purposes and it is appreciated that suitable variations are contemplated.

The diagram shows multiple parameters based combined weighted prioritization for UE cluster mapping.

The two techniques are described for UE cluster mapping, single parameter based selective codebook prioritization and multiple parameters based combined weighted prioritization.

The single parameter based selective codebook prioritization starts from UE measurement data for the parameter set, the selected single parameter based codebook is used to assign UEs to each clusters with parameter prioritization.

Multiple parameters based combined weighted prioritization starts from UE measurement data for the parameter set, the selected multiple parameters based multi-codebooks are used to assign UEs to each clusters with parameter prioritization.

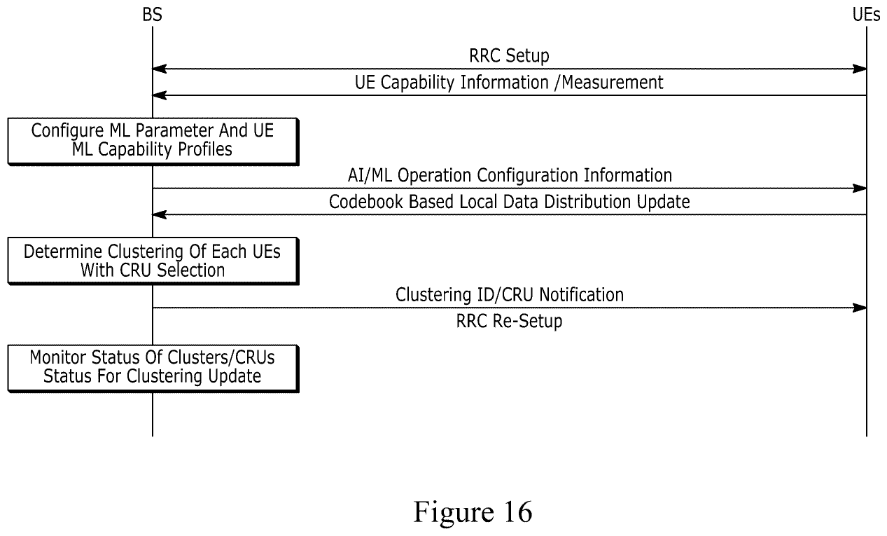

FIG. 16 is a diagram depicting operation of a BS and UEs with clustering with a codebook scheme in accordance with one or more embodiments. The diagram is provided for illustrative purposes and it is appreciated that suitable variations are contemplated.

A RRC setup is performed and signaled.

The UEs send UE capability information and/or measurement.

The BS configures ML parameter and UE ML capability profiles.

The BS sends AI/ML operation configuration information to the UEs.

The UEs send codebook based local data distribution to the BS.

The BS determines clustering of UEs with CRU selection.

The BS sends clustering ID/CRU notification and RRC re-setup.

The BS monitors status of clusters/CRUs status for clustering updates or changes.

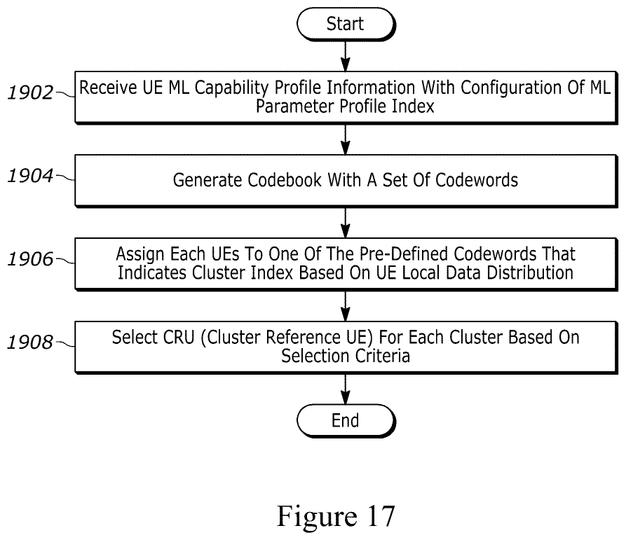

FIG. 17 is a flow diagram depicting a method of selecting CRU for each cluster in accordance with one or more embodiments. The diagram is provided for illustrative purposes and it is appreciated that suitable variations are contemplated.

The codebook clustering begins at 1902 where UE ML capability profile information with a configured of ML parameter profile index is received by the BS from the UEs.

A codebook with a set of codewords is generated at 1904.

Each of the UEs is assigned to one of the pre-defined codewords that indicate cluster index based on UE local data distribution at 1906.

A CRU is selected for each cluster based on selection criteria at 1908.

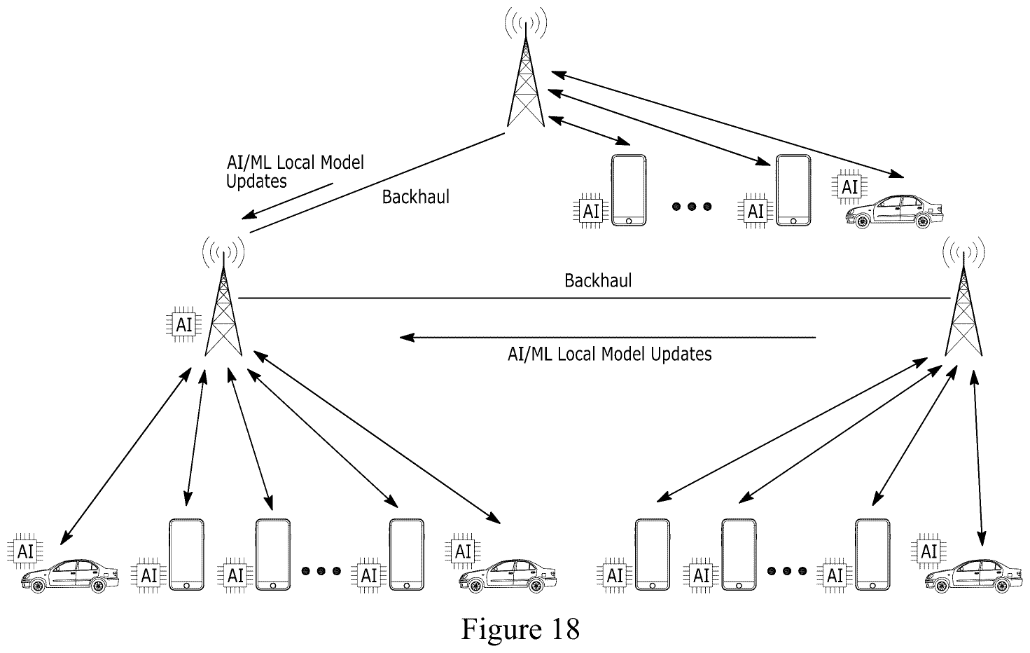

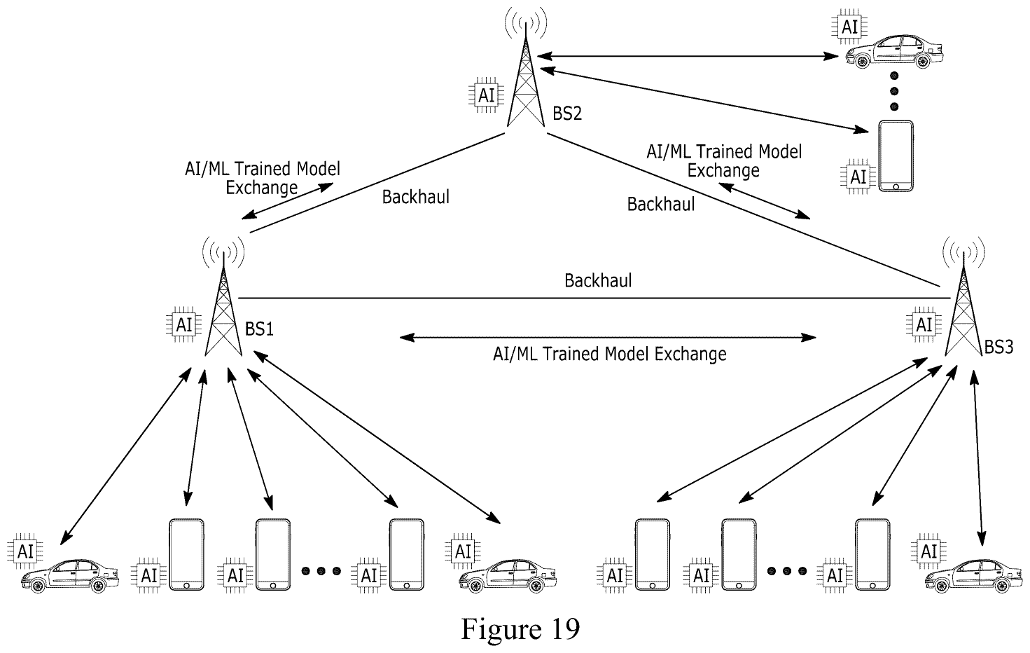

FIG. 18 is a diagram depicting UE mobility using BS-BS combined training in accordance with one or more embodiments. The diagram is provided for illustrative purposes and it is appreciated that suitable variations are contemplated.

In AI/ML operations with radio access network, UEs that are involved in AI/ML local model training have mobility by moving around across different BSs. AI/ML operation performance such as model training can be degraded due to convergence issues. UE mobility under AI/ML operation can be managed to mitigate or resolve such issues. In one example, a federated learning process is used.

To manage AI/ML operation performance degradation with UE mobility, BS to BS combined training or split training can be used. For this, BSs are connected to each other with neighbor BSs through a backhaul link. AI/ML model information is exchanged to support BS-BS combined/split training. The AI/ML model training update performed in each BS can be shared with each other.

The trained AI/ML model in each BS can be also used for transfer learning if necessary.

UE mobility can also trigger BS-BS based communication mode and AI/ML operation across the connected BSs can be activated by sharing AI/ML model update is performed.

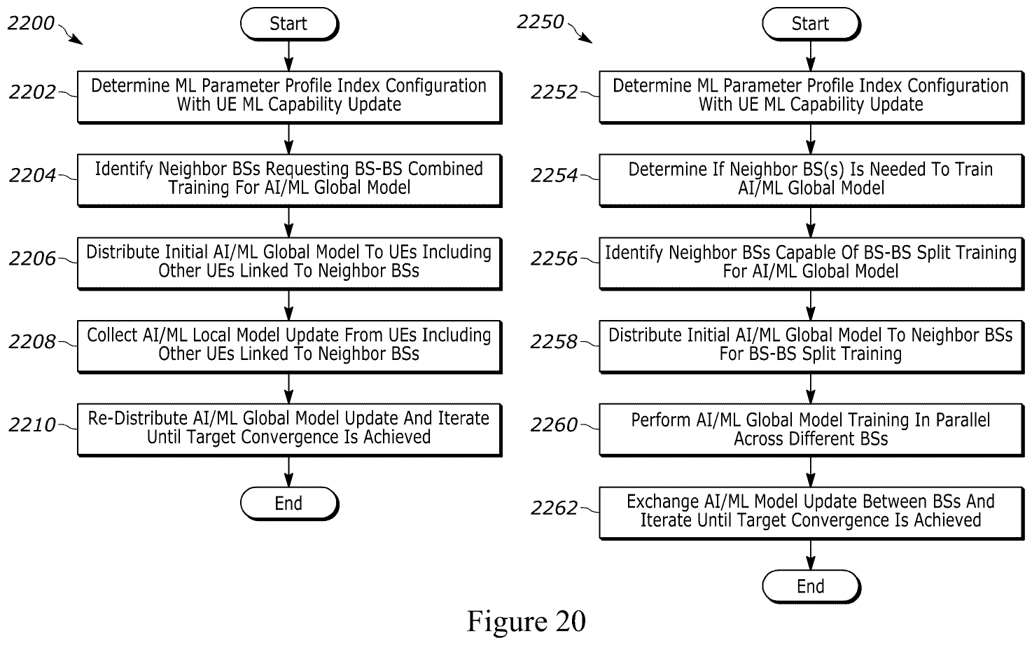

The combined training is shown as an example in FIG. 20. A BS collects AI/ML local model updates from UEs linked to neighbor BS(s) when performing AI/ML global model update.

### Possible Scenarios

When UEs move around across different BSs for connection, AI/ML local model training update from those UEs can continue to be served to contribute to AI/ML global model update if BS-BS combined training is supported.

Any single BS has a few number of UEs for AI/ML local model training, and BS-BS combined training can be then eligible to perform with enough number of UEs.

FIG. 19 is a diagram depicting UE mobility using BS-BS split training in accordance with one or more embodiments. The diagram is provided for illustrative purposes and it is appreciated that suitable variations are contemplated.

Two or more BSs share the same AI/ML global model for model training when each BSs have their own UEs in connection.

Possible scenarios: When UEs move around across different BSs for connection, AI/ML local model training update from those UEs can continue to be served to contribute to AI/ML global model update if BS-BS split training is supported.

Depending on BS's AI/ML capability status, a BS can optionally perform AI/ML model training together with neighbor BSs in parallel so that wider coverage of UE local model training can be obtained for AI/ML global model update.

FIG. 20 is a flow diagram illustrating a method using BS-BS combined training and/or BS-BS split training in accordance with one or more embodiments. The diagram is provided for illustrative purposes and it is appreciated that suitable variations are contemplated.

A method 2200 depicts BS-BS combined training.

A ML parameter profile index configured with UE ML capability update is determined at 2202.

Neighbor BSs requesting BS-BS combined training for AI/ML global model are identified at 2204.

Initial AI/ML global model is distributed to UEs including other UEs linked to the neighbor BSs at 2206.

A method 2250 depicts BS-BS split training.

A ML parameter profile index configuration with UE ML capability update is determined at 2252.

A determination is made if neighbor BSs is/are needed to train AI/ML global model at 2254.

Neighbor BSs capable of BS-BS split training for the AI/ML global model are identified at 2256.

Initial AI/ML global model is distributed to neighbor BSs for BS-BS split training at 2258.

AI/ML global model training is performed in parallel across different BSs at 2260.

AI/ML model update(s) are exchanged and iterated until a target convergence is achieved at 2262.

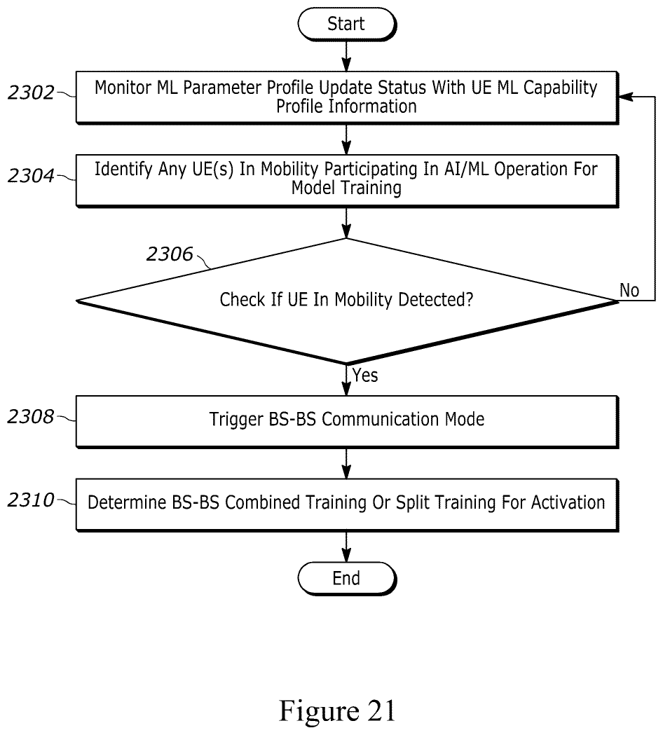

FIG. 21 is a flow diagram illustrating a method for UE mobility based triggering in accordance with one or more embodiments. The diagram is provided for illustrative purposes and it is appreciated that suitable variations are contemplated.

UE mobility is used to trigger communication mode that enables BS-BS combined or split training for AI/ML operation. Determination of communication mode to be used for AI/ML operation is based on ML parameter profile update and UE ML capability profile information. At the same time, a UE mobility based communication mode can then be activated when any UE in mobility occurs during AI/ML operation such as model training. In this scenario, UE mobility works as a triggering functionality to activate the associated communication mode for support of BS-BS combined/split training.

A ML parameter profile update status with UE ML capability profile information is monitored at 2302.

Any UEs in mobility participating in AI/ML operation for model training are identified at 2304.

The identified UE(s) are checked for mobility at 2306.

If yes, a BS-BS communication mode is triggered at 2308.

A BS-BS combined training or split training is determined for activation at 2310.

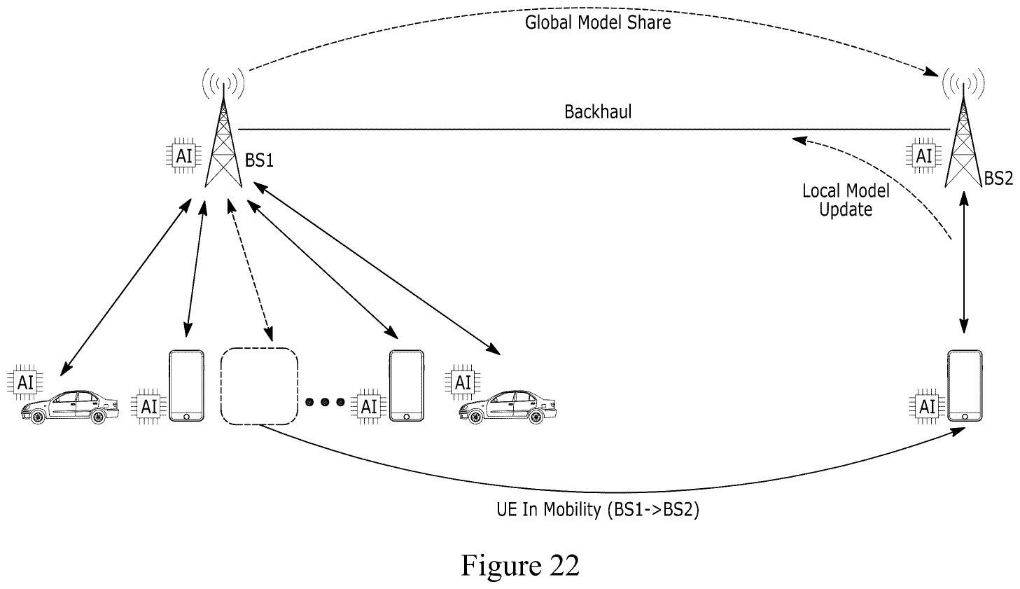

FIG. 22 is a diagram illustrating global model sharing in accordance with one or more embodiments. The diagram is provided for illustrative purposes and it is appreciated that suitable variations are contemplated.

Based on UE mobility as communication mode triggering for AI/ML operation of model training, a BS can either share AI/ML global model for training with neighbor BSs (as BS-BS split training) or collect AI/ML local model update from UEs linked to neighbor BSs (as BS-BS combined training).

The BS1 can share a global model with the BS2.

The BS2 can provide a local model update from the UE that has moved from BS1 to BS2.

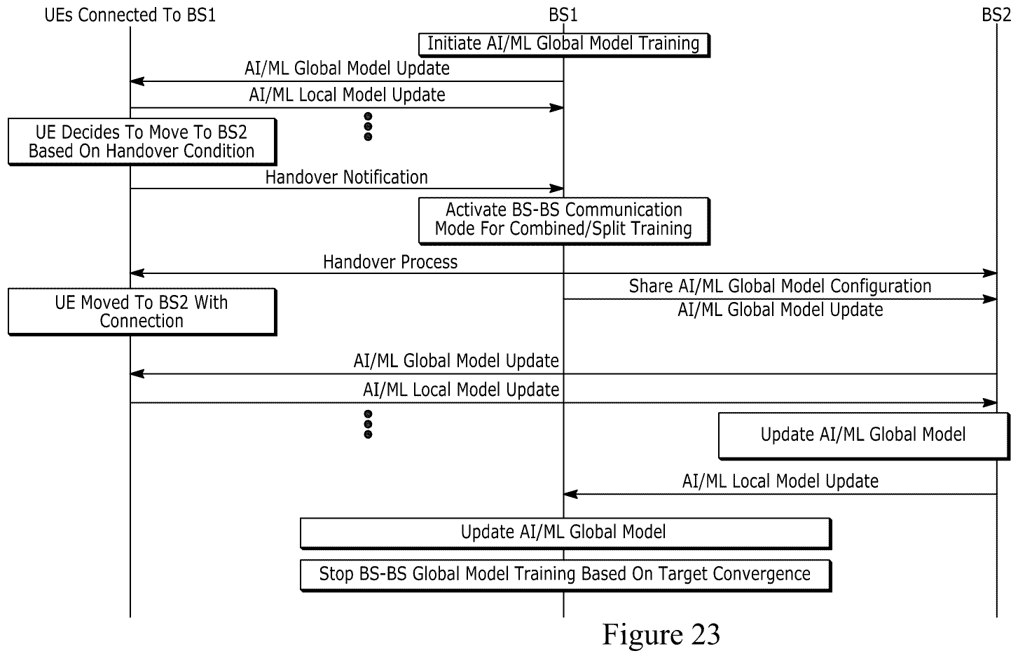

FIG. 23 is a diagram illustrating global model sharing in accordance with one or more embodiments. The diagram is provided for illustrative purposes and it is appreciated that suitable variations are contemplated.

The diagram depicts UEs connected to a BS1, the BS1 and a BS2.

The BS1 initiates AI/ML global model training.

The BS1 sends a AI/ML global model update to the UEs connected to BS1.

The UEs respond with AI/ML local model update(s).

A UE of the UEs decides to move to BS2 based on a handover condition.

The UE sends a handover notification to the BS1.

The BS1 activates BS-BS communication mode for combined/split training.

The handover process to the BS2 starts.

The UE is moved to the BS2 with a connection.

The BS2 sends an AI/ML global model update to the UE.

The UE sends an AI/ML local model update to the BS2.

The BS2 updates the global model based on the AI/ML local model update from the UE.

The BS2 provides the AI/ML local model update to the BS1.

The BS1 updates the AI/ML global model using the AI/ML local model from the BS2.

The BS1 stops BS-BS global model training based on a target convergence.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus, system, and the like to perform the actions.

One general aspect includes a system (100) having a base station (BS) (11 The system also includes a radio frequency (RF) interface; and one or more processors configured to: monitor a machine language (ml) parameter profile status (701) and ml capability profile (702) of user equipment (UE)s (101,102) linked to the bs; detect activation request of ai/ml operation (1006); determine communication mode based on parameter prioritization; share ai/ml operation (1006) configuration with a second base station (BS2) using the RF interface; determine UE clustering and determine a cluster reference UE (CRU); receive a UE local model from the CRU using the RF interface; receive a BS2 local model from the BS2 using the RF interface; update an AI/ML global model based on the UE local model and the bs2 local model; and release the UEs for training connection.

Implementations may include one or more of the following features. The system further including a UE may include: a radio frequency (RF) interface, a memory, and one or more processors configured to: generate a capability profile, generate a ml parameter profile, generate the UE local model, and perform training using the ue local model and/or the ai/ml global model. The one or more processors of the bs configured to generate a configuration of multi-communication modes and associated operation flows. The one or more processors of the bs configured to provide communication mode triggering method using UE clustering. The one or more processors of the bs configured to generate a gaussian mixture model (GMM) based quantization method for codebook mapping process. The one or more processors of the bs configured: to receive a machine language (ML) parameter profile may include a plurality of parameter sets for a plurality of domains; configure the plurality of parameter sets for multi-communication modes in ml operation. The one or more processors of the BS configured to generate a UE mobility based triggering method for ml operation of model training. The capability profile may include multiple domains to provide reference information regarding UE capability to perform ml operation. Implementations of the described techniques may include hardware, a method or process, or computer software on a computer-accessible medium.

One general aspect includes an apparatus for a base station (BS) (111). The apparatus also includes a radio frequency (RF) interface; and one or more processors configured to: receive a machine language (ML) parameter profile may include a plurality of parameter sets for a plurality of domains, configure the plurality of parameter sets for multi-communication modes in ml operation.

Implementations may include one or more of the following features. The one or more processors configured to receive a UE ml capability profile may include of multiple domains to provide reference information regarding UE capability to perform ML operation. The one or more processors configured to perform a UE mobility based bs-bs collaboration method for combined training and split training. The one or more processors configured to generate a UE mobility based triggering method for ml operation of model training. The one or more processors configured to generate a configuration of multi-communication modes and associated operation flows. The one or more processors configured to provide communication mode triggering method using ue clustering. The apparatus the one or more processors configured to generate a gaussian mixture model (GMM) based quantization method for codebook mapping process. Implementations of the described techniques may include hardware, a method or process, or computer software on a computer-accessible medium.

One general aspect includes an apparatus for a base station (BS) (111). The apparatus also includes a radio frequency (RF) interface; and one or more processors configured to: receive user equipment (UE) (101) measurements and capability profile reports for a plurality of UEs by the rf interface, determine one or more UE clusters for the plurality of UEs, determine a cluster reference UE (cru) for each of the one or more clusters, monitor ue mobility of the plurality of UEs, and determine change crus for the one or more clusters based on the monitored UE mobility.

Implementations may include one or more of the following features. The apparatus the one or more processors configured to identify available UE clustering based on the determined cru. The one or more processors configured to trigger UE clustering based communication mode for ai/ml operation. Implementations of the described techniques may include hardware, a method or process, or computer software on a computer-accessible medium.

One general aspect includes one or more computer-readable media having instructions that. The media also includes monitor a ml parameter profile and UE ML capability profile information. The media also includes identify one or more UEs in mobility and participating in AI/ML model training. The media also includes determine model training with a second base station (BS2).

Implementations may include one or more of the following features. The one or more computer readable media having instructions that, when executed cause the bs to further: detect an activation request of ai/ml operation; determine communication mode based on parameter prioritization; and share an AI/ML operation configuration with a second base station (BS2). Implementations of the described techniques may include hardware, a method or process, or computer software on a computer-accessible medium.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

As it is employed in the subject specification, the term “processor” can refer to substantially any computing processing unit or device including, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “store,” “data store,” data storage,” “database,” and substantially any other information storage component relevant to operation and functionality of a component and/or process, refer to “memory components,” or entities embodied in a “memory,” or components including the memory. It is noted that the memory components described herein can be either volatile memory or nonvolatile memory, or can include both volatile and nonvolatile memory.

By way of illustration, and not limitation, nonvolatile memory, for example, can be included in a memory, non-volatile memory (see below), disk storage (see below), and memory storage (see below). Further, nonvolatile memory can be included in read only memory, programmable read only memory, electrically programmable read only memory, electrically erasable programmable read only memory, or flash memory. Volatile memory can include random access memory, which acts as external cache memory.

It is to be understood that aspects described herein can be implemented by hardware, software, firmware, or any combination thereof. When implemented in software, functions can be stored on or transmitted over as one or more instructions or code on a computer-readable medium. Computer-readable media includes both computer storage media and communication media including any medium that facilitates transfer of a computer program from one place to another. A storage media or a computer readable storage device can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or other tangible and/or non-transitory medium, that can be used to carry or store desired information or executable instructions. Also, any connection is properly termed a computer-readable medium. For example, if software is transmitted from a website, server, or other remote source using a coaxial cable, fiber optic cable, twisted pair, digital subscriber line (DSL), or wireless technologies such as infrared, radio, and microwave, then coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Various illustrative logics, logical blocks, modules, and circuits described in connection with aspects disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform functions described herein. A general-purpose processor can be a microprocessor, but, in the alternative, processor can be any conventional processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration. Additionally, at least one processor can comprise one or more modules operable to perform one or more of the functions and/or actions described herein.

For a software implementation, techniques described herein can be implemented with modules (e.g., procedures, functions, and so on) that perform functions described herein. Software codes can be stored in memory units and executed by processors. Memory unit can be implemented within processor or external to processor, in which case memory unit can be communicatively coupled to processor through various means as is known in the art. Further, at least one processor can include one or more modules operable to perform functions described herein.

Techniques described herein can be used for various wireless communication systems such as CDMA, TDMA, FDMA, OFDMA, SC-FDMA and other systems. The terms “system” and “network” are often used interchangeably. A CDMA system can implement a radio technology such as Universal Terrestrial Radio Access (UTRA), CDMA1800, etc. UTRA includes Wideband-CDMA (W-CDMA) and other variants of CDMA. Further, CDMA1800 covers IS-1800, IS-95 and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.18, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on downlink and SC-FDMA on uplink. UTRA, E-UTRA, UMTS, LTE and GSM are described in documents from an organization named “3rd Generation Partnership Project” (3GPP). Additionally, CDMA1800 and UMB are described in documents from an organization named “3rd Generation Partnership Project 2” (3GPP2). Further, such wireless communication systems can additionally include peer-to-peer (e.g., mobile-to-mobile) ad hoc network systems often using unpaired unlicensed spectrums, 802.xx wireless LAN, BLUETOOTH and any other short-or long-range, wireless communication techniques.

Single carrier frequency division multiple access (SC-FDMA), which utilizes single carrier modulation and frequency domain equalization is a technique that can be utilized with the disclosed aspects. SC-FDMA has similar performance and essentially a similar overall complexity as those of OFDMA system. SC-FDMA signal has lower peak-to-average power ratio (PAPR) because of its inherent single carrier structure. SC-FDMA can be utilized in uplink communications where lower PAPR can benefit a mobile terminal in terms of transmit power efficiency.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product can include a computer readable medium having one or more instructions or codes operable to cause a computer to perform functions described herein.

Communications media embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Further, the actions of a method or algorithm described in connection with aspects disclosed herein can be embodied directly in hardware, in a software module executed by a processor, or a combination thereof. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to processor, such that processor can read information from, and write information to, storage medium. In the alternative, storage medium can be integral to processor. Further, in some aspects, processor and storage medium can reside in an ASIC. Additionally, ASIC can reside in a user terminal. In the alternative, processor and storage medium can reside as discrete components in a user terminal. Additionally, in some aspects, the s and/or actions of a method or algorithm can reside as one or any combination or set of codes and/or instructions on a machine-readable medium and/or computer readable medium, which can be incorporated into a computer program product.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In particular regard to the various functions performed by the above described components (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the disclosure. In addition, while a particular feature may have been disclosed with respect to only one of several implementations, such feature may be combined with one or more other features of the other implementations as may be desired and advantageous for any given or particular application.

1. A system having a base station (BS), comprising circuitry having:
a radio frequency (RF) interface; and
one or more processors configured to:
monitor a machine language (ML) parameter profile status and ML capability profile of user equipment (UE)s linked to the BS;
detect activation request of Al/ML operation;
determine communication mode based on parameter prioritization;
share AI/ML operation configuration with a second base station using the RF interface;
determine UE clustering and determine a cluster reference UE (CRU);
receive a UE local model from the CRU using the RF interface;
receive a BS2 local model from the BS2 using the RF interface;
update an AI/ML global model based on the UE local model and the BS2 local model; and
release the UEs for training connection.

2. The system of claim 1 further including a UE comprising:
a radio frequency (RF) interface;
a memory; and
one or more processors configured to:
generate a capability profile;
generate a ML parameter profile;
generate the UE local model; and
perform training using the UE local model and/or the AI/ML global model.

3. The system of claim 1, the capability profile comprising multiple domains to provide reference information regarding UE capability to perform ML operation.

4. The system of claim 1, the one or more processors of the BS configured to generate a configuration of multi-communication modes and associated operation flows.

5. The system of claim 1, the one or more processors of the BS configured to provide communication mode triggering method using UE clustering.

6. The system of claim 1, the one or more processors of the BS configured to generate a Gaussian mixture model (GMM) based quantization method for codebook mapping process.

7. The system of claim 1, the one or more processors of the BS configured:
to receive a machine language (ML) parameter profile comprising a plurality of parameter sets for a plurality of domains;
configure the plurality of parameter sets for multi-communication modes in ML operation.

8. The system of claim 1, the one or more processors of the BS configured to generate a UE mobility based triggering method for ML operation of model training.

9. An apparatus for a base station (BS), comprising circuitry having:
a radio frequency (RF) interface; and
one or more processors configured to:
receive a machine language (ML) parameter profile comprising a plurality of parameter sets for a plurality of domains;
configure the plurality of parameter sets for multi-communication modes in ML operation.

10. The apparatus of claim 9, the one or more processors configured to receive a UE ML capability profile consisting of multiple domains to provide reference information regarding UE capability to perform ML operation.

11. The apparatus of claim 9, the one or more processors configured to generate a configuration of multi-communication modes and associated operation flows.

12. The apparatus of claim 9, the one or more processors configured to provide communication mode triggering method using UE clustering.

13. The apparatus of claim 9, the one or more processors configured to generate a Gaussian mixture model (GMM) based quantization method for codebook mapping process.

14. The apparatus of claim 9, the one or more processors configured to perform a UE mobility based BS-BS collaboration method for combined training and split training.

15. The apparatus of claim 9, the one or more processors configured to generate a UE mobility based triggering method for ML operation of model training.

16. An apparatus for a base station (BS), comprising circuitry having:
a radio frequency (RF) interface; and
one or more processors configured to:
receive user equipment (UE) measurements and capability profile reports for a plurality of UEs by the RF interface;
determine one or more UE clusters for the plurality of UEs;
determine a cluster reference UE (CRU) for each of the one or more clusters;
monitor UE mobility of the plurality of UEs; and
determine change CRUs for the one or more clusters based on the monitored UE mobility.

17. The apparatus of claim 16, the one or more processors configured to identify available UE clustering based on the determined CRU.

18. The apparatus of claim 16, the one or more processors configured to trigger UE clustering based communication mode for AI/ML operation.

19. One or more computer-readable media having instructions that, when executed, cause a base station (BS) to:
monitor a ML parameter profile and UE ML capability profile information;
identify one or more UEs in mobility and participating in AI/ML model training;
determine model training with a second base station (BS2).

20. The one or more computer readable media of claim 19 having instructions that, when executed cause the BS to further:
detect an activation request of AI/ML operation;
determine communication mode based on parameter prioritization; and
share an AI/ML operation configuration with a second base station (BS2).
